(19) United States
(12) Patent Application Publication
(10) Pub. No.: US 2019/0291977 A1
(43) Pub. Date: Sep. 26, 2019

(54) Conveying System for Bulk Goods, in Particular Plastic Granules, and Method for Conveying Bulk Goods, in Particular Plastic Granules

(71) Applicant: Walter KRAMER, Hünenberg See (CH)

(72) Inventor: Walter KRAMER, Hünenberg See (CH)

(21) Appl. No.: 16/306,588

(22) PCT Filed: Jun. 1, 2017
(86) PCT No.: PCT/EP2017/000642

§ 371 Date: Dec. 3, 2018

(30) Foreign Application Priority Data
Jun. 3, 2016 (DE) 10 2016 007 061.7

(51) Int. Cl. B65G 53/56; B65G 53/36

(52) U.S. Cl. CPC B65G 53/56; B65G 53/36

(57) ABSTRACT

The invention relates to a conveying system for bulk goods, in particular plastic granules, which conveying system has at least two senders (A to C) and at least two receivers (I to IV), which are connected to each other by conveying lines (7 to 9) via at least one switch station (1). The switch station (1) has at least two inlets (4 to 6) and at least two outlets (10 to 12), which are each provided with a valve (13) and which are provided on a coupling tube (2) that connects the inlets (4 to 6) and the outlets (10 to 12). The switch station (1) has at least one venting valve (14, 15, 32), which is provided on the coupling tube (2).

The invention concerns a conveying system for bulk goods, in particular plastic granules, according to the preamble of claim 1 as well as a method for conveying bulk goods, in particular plastic granules, according to the preamble of claim 12.

In conveying systems for bulk goods, senders, which contain the bulk goods and are silos, for example, are connected by conduits to receivers. In general, such receivers are positioned on processing machines with which the bulk goods are processed. The senders contain different types of bulk goods which are selectively supplied to the individual receivers. In order to connect selected senders with selected receivers, a switch station is provided which comprises inlets and outlets wherein the senders are connected to the inlets and the receivers to the outlets.

In known conveying systems, flexible hoses, which are connected with one end to the conduits extending to the receivers, are connected in the switch stations by hand to the respective inlets in order to connect in this way a selected sender with the selected receiver. Aside from the constructive expenditure, the manual coupling of the flexible hoses to the respective inlets is cumbersome.

In other known conveying systems, connecting members embodied telescope-like are provided instead of the flexible hoses and are arranged at the conduits leading to the receivers and must be connected selectively to the corresponding sender conduits. Such a conveying system is also correspondingly complex and cumbersome in regard to handling.

Different bulk goods are supplied to the receivers. It is therefore necessary that, when changing from one type to another type of bulk goods, the conveying conduits must be free of the bulk goods conveyed previously. In practice, it has been found that residues of the previously conveyed bulk goods still remain in the conveying conduit and will mix with the other type of bulk goods to be conveyed in this conveying conduit.

It is the object of the invention to configure the conveying system of the aforementioned kind and the method of the aforementioned kind such that a change of the type of bulk goods to be conveyed is possible without problems with a simple constructive configuration and handling.

This object is solved for the conveying system of the aforementioned kind in accordance with the invention with the characterizing features of claim 1 and for the method of the aforementioned kind in accordance with the invention with the characterizing features of claim 12.

With the conveying system according to the invention, different types of bulk goods can be conveyed from the respective senders to the receivers. The inlets connected to the senders and the outlets connected to the receivers of the switch station are opened and closed by a valve, respectively. The valves can be easily adjusted between the open and the closed position, preferably adjusted in a controlled fashion. By means of a suction blower, the bulk goods are conveyed from the selected sender to the selected receiver, wherein the corresponding valves in the conveying conduit are opened. As soon as the receiver has received the required quantity of bulk goods, the venting valve that is closed during the conveying process is opened. In this way, conveyance from the sender to the receiver is immediately interrupted. The suction blower continues to operate so that it is ensured that residual material still contained in the conveying conduit is sucked to the receiver. In this way, no residual material of the conveyed bulk goods remains in the conduit. The cleaning process which is started by opening the venting valve ensures that no residual material remains in the conveying conduit. As soon as the cleaning process has been completed, the suction blower is separated from the receiver by closing a corresponding valve. Accordingly, the vacuum in the conveying conduit from this receiver to the sender collapses because the venting valve is still open. Due to the cleaning process, the receiver subsequently can be supplied with another type of bulk goods. Due to the cleaning process, it is ensured that the new type of bulk goods is not contaminated by parts of the previous type of bulk goods. Prior to starting the new conveying process, the venting valve is closed again and the valve between the suction blower and the receiver is opened.

Advantageously, the coupling pipe has two pipe sections. One pipe section is provided with the inlets and the other pipe section with the outlets. Depending on the length of these two pipe sections, a different number of inlets and outlets can be provided. Such a conveying system can be upgraded by attaching additional inlets and/or outlets.

An advantageous embodiment results when the coupling pipe is embodied in a U-shape. In such a case, the two legs of the U-shaped coupling pipe form the pipe sections where the inlets or the outlets are provided. The U-shaped configuration of the coupling pipe leads to a very compact configuration that requires only little space.

The pipe sections of the coupling pipe may also be arranged angularly relative to each other, for example, at a right angle.

The venting valve with which the cleaning action of the conveying conduit is performed, is advantageously seated at the free end of the pipe section provided with the inlets. In this way, a cleaning action can be performed independent of through which inlet the bulk goods are supplied.

The cleaning action can still be further improved when a further venting valve is provided also at the free end of the pipe section provided with the outlets. When this further venting valve is opened, a counter flow is produced which ensures that residual particles are removed that are still contained in the region between this further venting valve and the respective outlet. These residual particles may get caught, for example, due to electrostatic charging, at the inner wall of the conveying conduit. These particles are entrained by the counter flow.

Advantageously, the further venting valve is provided with a smaller opening cross section than the other venting valve. In this way, it is ensured that the main flow which is formed through this other venting valve conveys the residual material entrained by the counter flow in the direction toward the receiver. In this way, an optimal cleaning action of the respective conveying conduit is ensured.

In a further advantageous embodiment, the coupling pipe is provided with a third venting valve in the region between the inlets and the outlets. It ensures that no material is accidentally sucked in from the sender when the first venting valve is open.

An optimal operation of the conveying system results when all valves are connected to a common control unit. Then these valves can be switched exactly at the right point in time in order to start a new conveying process or to clean the conveying conduit after completion of the conveying process.

Advantageously, the discharge valves provided at the senders as well as the valves, provided at the receivers and connecting the receivers to the suction blower, are also connected to the control unit. In this way, a completely automated operation of the conveying system is possible.

In order for the conveying system and in particular the switch station to require only little space even for a plurality of inlets or outlets, it is advantageously provided that the inlets and/or the outlets are arranged at the corresponding pipe sections of the coupling pipe alternatingly angularly displaced relative to each other. In this way, the inlets or outlets which are present along the pipe sections can be displaced relative to each other by, for example, 90°. In this case, the next but one inlets or outlets, respectively, are positioned one after the other, viewed in axial direction of the pipe sections. This angularly displaced arrangement has also the advantage that corresponding inlets or outlets can be easily installed and connected in a simple way with the control unit in regard to control technology.

In the method according to the invention, the venting valve is opened shortly before completion of a conveying process. During the conveying process, the venting valve is closed. Upon opening of the venting valve, conveyance of the bulk goods from the sender to the receiver is immediately interrupted. The suction blower continues to operate so that the residual material which is still contained in the conveying conduit is sucked into the receiver. Due to the opened venting valve, a portion of the venting flow also reaches the conveying conduit section extending to the sender. In this way, adhering bulk goods particles in the region of the inlet in the direction toward the sender are also cleaned off.

It is advantageous when a further venting valve is opened after a temporal delay. With it, in the selected conveying conduit a counter flow is generated which then will entrain those particles of the bulk goods which, for example, due to electrostatic charging, have gotten caught on the inner wall of the conveying conduit. These particles then reach the main flow which is generated by the other opened venting valve in the conveying conduit. This main flow absorbs the particles that are engaged and entrained by the counter flow and conveys them to the receiver. In this way, the conveying conduit can be optimally cleaned.

In a further advantageous embodiment, after a further temporal delay a third venting valve is opened which is located at the coupling pipe of the switch station in the region between the first and the second venting valve. This third venting valve forms a safety valve that prevents that minimal bulk goods material that may still be sucked in from the sender reaches the conveying conduit. In this way, the first venting valve can be designed such that it generates a sufficiently strong main flow in order to clean the conveying conduit reliably without there being the risk that accidentally bulk goods particles are sucked in from the sender due to this strong main flow.

A simple and still reliable process control results when all valves are connected to a control unit.

The subject matter of the application results not only from the subject matter of the individual claims but also from the specifications and features disclosed in the drawings and the description. They are considered important to the invention, even if they are not subject matter of the claims, inasmuch as individually or in combination they are novel relative to the prior art.

Further features of the invention result from the further claims, the description, and the drawings.

The invention will be explained in more detail with the aid of two embodiments illustrated in the drawings. It is shown in:

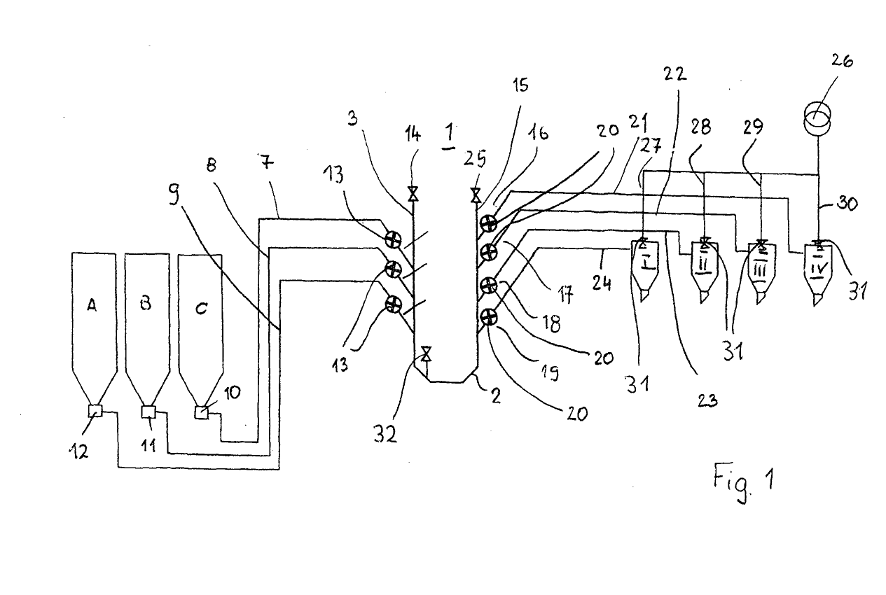

FIG. 1 in schematic illustration a conveying system according to the invention;

FIG. 2 a side view of a switch station of the conveying system according to the invention;

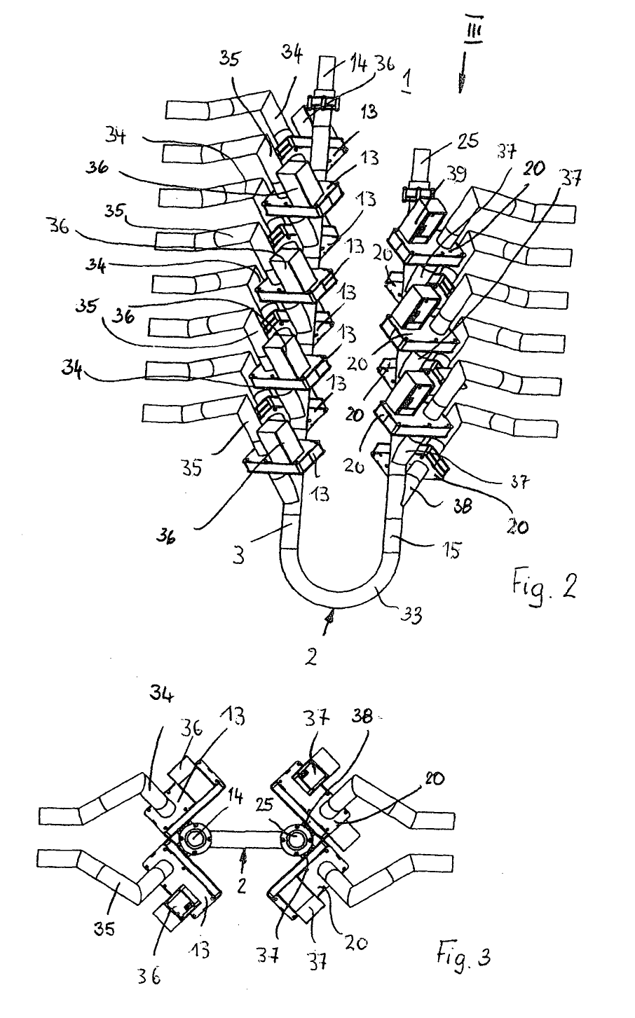

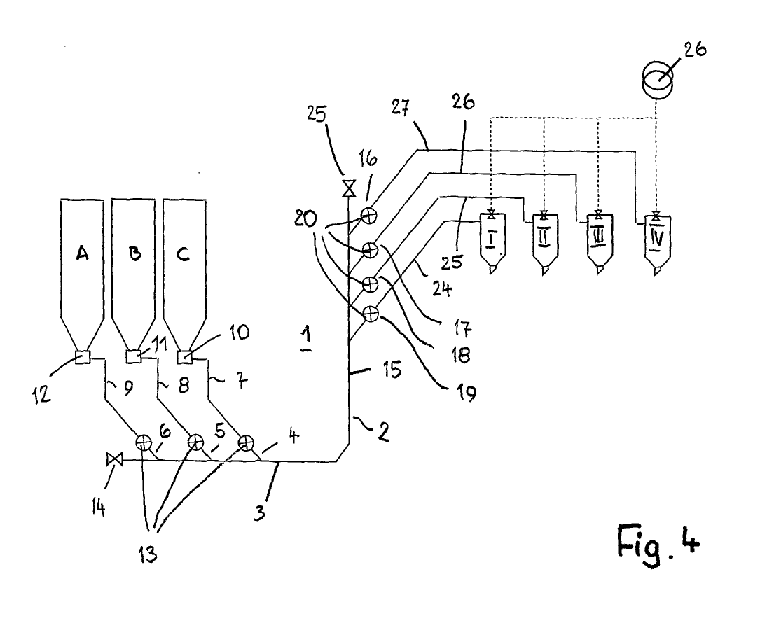

FIG. 3 a view in the direction of arrow III in FIG. 2;

FIG. 4 in schematic illustration a second embodiment of a conveying system according to the invention.

Bulk goods, in particular plastic granules, are transported with the conveying system from senders to receivers. For example, the conveying system has three senders A to C which can be connected, for example, to four receivers I to IV through conduits. In order to be able to connect the senders A to C selectively with the receivers I to IV, a switch station 1 is provided with which the conduit connection between the senders A to C and the receivers I to IV can be produced selectively. The senders A to C are storage containers, such as silos, in which the bulk goods are stored. The receivers I to IV are positioned on processing machines (not illustrated) with which the bulk goods are processed. In the receivers I to IV, the bulk goods are collected and separated from the air.

The switch station 1 has a central coupling pipe 2 which is advantageously of a U-shaped configuration. At one pipe leg 3, inlets 4 to 6 are provided which are connected through conduits 7 to 9 to discharge units 10 to 12 of the senders A to C. The discharge units 10 to 12 are provided with discharge valves which are opened when conveying the bulk goods away from the respective senders A to C. The inlets 4 to 6 are branch pipes that are connected to the pipe leg 3 and extend upwardly and in which a valve 13 is seated, respectively, with which the passage of the respective inlet 4 to 6 can be opened or closed. In the installed position, the pipe leg 3 extends advantageously upwardly and is provided at the free end with a venting valve 14. It is closed during the conveying process.

At the other pipe leg 15 of the coupling pipe 2, outlets 16 to 19 are provided which are also formed as branch pipes which are extending away from the pipe leg 15 at a slant upwardly. A valve 20 is seated at the outlets 16 to 19, respectively. The passage of the outlets 16 to 19 can be selectively opened and closed by the valves 20. The outlets 16 to 19 are connected by a respective conduit 21 to 24 with the receivers I to IV.

At the free end of the pipe leg 15 that advantageously extends upwardly and parallel to the pipe leg 3, a venting valve 25 is provided which is closed during conveying.

For conveying the bulk goods from the senders A to C to the receivers I to IV, at least one suction blower 26 is provided that is connected by suction lines 27 to 30 to the receivers I to IV. These suction lines 27 to 30 open at the cover part of the receivers I to IV. The conveying conduits 21 to 24 are connected laterally near the ceiling to the receivers I to IV. Within the receivers I to IV, in a manner known in the art, grids or filters (not illustrated) are provided with which the conveyed bulk goods are separated from the air. The bulk goods remains in the receiver I to IV while the air reaches the suction lines 27 to 30.

By means of the switch station 1, the valves 13, 20 are switched such that the bulk goods are conveyed from the corresponding senders A to C to the desired receiver I to IV.

In order to be able to convey the bulk goods, for example, from the sender A to the receiver I, the valve 13 in the inlet 6 is opened so that the bulk goods via the conduit 9 and the open inlet 6 can reach the coupling pipe 2. The valve 20 of the outlet 19 is open so that the bulk goods can be conveyed through conduit 24 to the receiver I. The other valves 13, 20 are closed in this example.

In this way, depending on the open valve 13, 20, the sender A to C can be connected selectively with any of the receivers I to IV. By means of the blower 26 the bulk goods are removed by suction from the sender and supplied to the respective receiver.

In the described example, the valves 13 of the inlets 4, 5 as well as the valves 20 of the outlets 16 to 18 are closed. The venting valves 14, 25 are closed also.

Shortly before the conveying process is terminated, the venting valve 14 is opened by means of a control unit. In this way, conveying of the bulk goods from the sender A to the receiver I is interrupted immediately. Since the suction blower 26 continues to operate, the residual material of the bulk goods still contained in the conduits 9, 24 is sucked to the receiver I. A portion of the air flow which passes through the open venting valve 14 into the coupling pipe 2 flows also in the direction toward the sender A so that adhering bulk goods particles are cleaned off the inlet 6.

In the suction lines 27 to 30, preferably at the receivers I to IV, a valve 31 is seated, respectively, by means of which the suction blower 26 can be connected with the respective receivers I to IV. Since in the described example the bulk goods are conveyed from sender A to receiver I, the valves 31 of the receivers II to IV are closed during the conveying process.

The valve 31 of the receiver I remains open during the described cleaning process so that the suction flow to the receiver I is maintained, even for opened venting valve 14.

When the cleaning process is terminated, the valve 31 of the receiver I is closed. This causes the vacuum in the conduits 24, 3, 15, 6, and 9 to collapse because the venting valve 14 is still open. Subsequently, the valves 13 and 20 at the inlet 6 as well as at the outlet 19 are closed.

In order for the different valves 13, 20, 31 to be opened or closed properly, they are connected to a control unit (not illustrated) with which they can be opened and closed in a targeted fashion.

After completion of the cleaning process, the control unit checks whether the valves 13 and 20 at the inlet 6 as well as the outlet 19 and the valve 31 are closed. As soon as one of the receivers I to IV demands new material, the control unit switches the corresponding valves 13, 20, 31 in such a way that the respective sender A to C is connected with the respective receiver I to IV. The corresponding valves 13, 20, 31 are opened. At the same time or shortly beforehand, the venting valve 14 in the switch station 1 is closed. The corresponding valve 31 in the receivers I to IV can now be opened so that the bulk goods from the selected sender A to C can be supplied to the receiver I to IV with the opened valve 31.

For improving the cleaning process in the region of the switch station 1, it is advantageous when the coupling pipe 2 comprises the second venting valve 25 which, like the venting valve 14, is also closed during the conveying process.

When the desired conveying quantity is reached, the venting valve 14 opens in the described way. In this way, the conveying stream in the respective sender conduit 7 to 9 is immediately stopped. After a temporal delay, the venting valve 25 of the switch station 1 is also opened.

The venting valve 25 is configured such that the counter flow that is produced by opening this venting valve 25 is minimal in comparison to the main flow which is produced by opening the venting valve 14. The counter flow which is produced by opening the venting valve 25 ensures that bulk goods, that are possibly contained in the region between the venting valve 25 and the respective outlet 16 to 19 and, for example, have gotten caught due to electrostatic charging on the inner wall of the pipe leg, will drop down and then be entrained in a reliable manner by the main flow which is produced by the opened venting valve 14.

Advantageously, in the region between the inlets 4 to 6 and the outlets 16 to 19 a further venting valve 32 is provided that ensures that material is not accidentally still sucked in minimally from the respective sender A to C.

In the illustrated and preferred embodiment, the switch station 1 is provided with the three venting valves 14, 25, 32. They are closed during conveyance of the bulk goods. Once the desired conveying quantity has been conveyed from sender A to C to the receiver I to IV, first the venting valve 14 is opened so that the conveying stream is immediately stopped in the sender conduit. After a temporal delay, the venting valve 25 is opened for emptying the conduits by suction. After a further temporal delay, the venting valve 32 is opened. In this way, it is ensured that the pipe conduits are cleaned, in particular the passage of the bulk goods through the inlets 4 to 6 to the outlets 16 to 19. Subsequently, the blower 26 is switched off. Subsequently, a new conveying process can be started.

All valves 13, 14, 20, 25, 31, 32 are connected to the control unit of the conveying system so that the conveying process including the cleaning action can be controlled automatically.

FIGS. 2 and 3 show a concrete embodiment of the switch station 1 with the U-shaped coupling pipe 2. It has the two upwardly oriented pipe legs 3, 15 positioned parallel to each other which pass into each other by a curved piece 33. The inlets 34, 35 which are formed by pipe sections oriented at a slant upwardly are branching off the pipe leg 3 at a slant in upward direction. In each inlet 34, 35 there is a valve 13 which is advantageously embodied as a slide valve that can be actuated by means of a drive 36, preferably an electric motor. Such motor-driven valves are known and are therefore not explained in detail.

In order to obtain a compact configuration of the switch station 1, the branch pipes 34, 35, in longitudinal direction of the pipe leg 3, are provided alternatingly displaced by approximately 90° relative to each other, respectively. In this way, the branch pipes 34, 35 with the corresponding valves 13 can be positioned very close next to each other.

The outlets 37, 38 are branch pipes which are oriented at a slant upwardly which alternatingly are displaced relative to each other by, for example, 90° (FIG. 3). In this way, very many outlets 37, 38 can be provided at the pipe leg 15 with minimal space requirement. Each one of the outlets 37, 38 has the valve 20 which is advantageously embodied as a slide valve. It is provided advantageously with a drive 39 which advantageously is an electric motor. The valves 20 with the drives 39 are preferably embodied identical to the valves 13 with the corresponding drives 36.

As is shown in an exemplary fashion in FIGS. 2 and 3, the switch station, despite the plurality of inlets 34, 35 as well as outlets 37, 38 with the respective valves 13, 20 and the drives 36, 39, requires only little space. The valves 13, 20 are arranged such and oriented relative to each other such that the valves of the pipe leg 3 are oriented in the direction toward the valves 20 of the pipe leg 15 and vice versa. In plan view according to FIG. 3, the valves 13 or 20 are arranged such that they form a V wherein the pipe legs 3, 15 are positioned closely adjacent to the V tip.

Due to the described position of the valves 13, 20, the drives 36, 37 in the installed position are easily accessible so that repairs and/or service work can be performed easily without conduits or conduit sections having to be removed.

All inlets and outlets of the switch station 1 are rigid and stationarily arranged. In order to be able to connect the senders A to C to the different receivers I to IV, it is only necessary to open the respective valves 13, 20. It is therefore not required to decouple conduits and newly couple them. The conduits located between the senders A to C and the receivers I to IV are stationarily arranged. In this way, a simple change of the connections between sender and receiver is possible. After each conveying process, cleaning of bulk goods from the pipes is achieved by means of the venting valves 14, 25, 32; no problems are observed when changing the bulk goods to be conveyed.

The senders A to C may contain different types of bulk goods that selectively can be supplied to one or several of the receivers I to IV. Since after the conveying process the described cleaning action is performed, a change of the bulk goods to be conveyed is possible without problem.

The receivers I to IV are filled in a known manner with a predetermined quantity of bulk goods (conveying batch) which subsequently is dispensed to the processing machine. For this purpose, the receivers I to IV are provided with a closable discharge unit in the form of a discharge valve that is opened for dispensing. As soon as the discharge unit is closed again, the next filling cycle can be performed.

FIG. 4 shows an embodiment which is embodied substantially identical to the embodiment according to the FIGS. 1 to 3. The switch station 1 in the embodiment according to FIG. 4 has the coupling pipe 2 whose two pipe legs 3, 15 are positioned at a right angle relative to each other. At the pipe leg 3 there are the inlets 4 to 6 to which, through the conduits 7 to 9, the discharge units 10 to 12 of the senders A to C are connected in the described way.

At the pipe leg 15, the outlets 16 to 19 are provided which are connected by conduits 24 to 27 with the receivers I to IV.

The venting valve 14 is located at the free end of the pipe leg 3 extending horizontally in FIG. 4. The venting valve 25 is provided at the free end of the pipe leg 15 extending vertically in FIG. 4.

In other respects, the embodiment is of the same configuration as the embodiment of FIGS. 1 through 3. The conveying system operates in the same manner as has been explained in connection with FIGS. 1 to 3.

The inlets 4 to 6 and the outlets 16 to 19 each are embodied as branch pipes which extend upwardly and in which a valve 13, 20 is seated, respectively, with which the passage of the respective inlet or outlet can be opened or closed selectively.

The two pipe legs 3, 15 of the coupling pipe 2 can also be positioned relative to each other at an angle deviating from 90°. In this way, the local conditions can be taken into account. In this case, the inlets 4 to 6 and the outlets 16 to 19 are also branch pipes extending at a slant upwardly.

The venting valve 32 of the preceding embodiment can also be provided in the embodiment according to FIG. 4.

What is claimed is:

1.-15. (canceled)

16. A conveying system for bulk goods, the conveying system comprising:
at least two senders;
at least two receivers;
at least one switch station comprising at least two inlets and at least two outlets, wherein the at least two inlets each comprises an inlet valve, and wherein the at least two outlets each comprise an outlet valve;
first conveying conduits connecting the at least two senders to the at least two inlets of the at least one switch station;
second conveying conduits connecting the at least two receivers to the at least two outlets of the at least one switch station;
wherein the at least one switch station further comprises a coupling pipe connecting the at least two inlets and the at least two outlets to each other;
wherein the at least one switch station further comprises a first venting valve provided at the coupling pipe.

17. The conveying system according to claim 16, wherein the coupling pipe comprises a first pipe section and a second pipe section, wherein the at least two inlets are arranged at the first pipe section and wherein the at least two outlets are arranged at the second pipe section.

18. The conveying system according to claim 17, wherein the coupling pipe has a U-shape and the first and second pipe sections form two legs of the U-shape of the coupling pipe.

19. The conveying system according to claim 17, wherein the first venting valve is provided at a free end of the first pipe section.

20. The conveying system according to claim 17, wherein the at least one switch station comprises a second venting valve arranged at a free end of the second pipe section.

21. The conveying system according to claim 20, wherein the second venting valve comprises an opening cross section that is smaller than an opening cross section of the first venting valve.

22. The conveying system according to claim 20, wherein the at least one switch station comprises a third venting valve arranged at the coupling pipe in a region between the at least two inlets and the at least two outlets.

23. The conveying system according to claim 22, wherein the inlet valves, the outlet valves, and the first, second, and third venting valves are connected to a common control unit.

24. The conveying system according to claim 23, wherein the at least two senders and the at least two receivers are provided with discharge valves connected to the common control unit.

25. The conveying system according to claim 16, wherein the at least two inlets are arranged at a first pipe section of the coupling pipe alternatingly angularly displaced relative to each other.

26. The conveying system according to claim 25, wherein the at least two outlets are arranged at a second pipe section of the coupling pipe alternatingly angularly displaced relative to each other.

27. A method for conveying bulk goods in the conveying system according to claim 16, the method comprising:
generating a conveying process by suction to convey the bulk goods in a conveying stream from a selected sender to a selected receiver through selected first and second conveying conduits;
shortly before terminating the conveying process, opening a venting valve to stop the conveying stream in the selected first and second conveying conduits.

28. The method according to claim 27, further comprising, after a first temporal delay, opening a second venting valve to generate a counter flow in the selected conveying conduit.

29. The method according to claim 28, further comprising, after a second temporal delay, opening a third venting valve provided at the coupling pipe of the switch station in a region between the first and the second venting valves.

30. The method according to claim 28, further comprising switching all valves of the conveying system by a common control unit.
